(19) United States
(12) Patent Application Publication
(10) Pub. No.: US 2010/0120350 A1
(43) Pub. Date: May 13, 2010

(54) AIR KNIFE

(75) Inventor: Allen S. Pucciani, Beavercreek, OH (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc., Glenview, IL (US)

(21) Appl. No.: 12/614,359

(22) Filed: Nov. 6, 2009

Related U.S. Application Data
(60) Provisional application No. 61/112,775, filed on Nov. 9, 2008.

(51) Int. Cl. F24F 9/00; F24F 13/06

(52) U.S. Cl. 454/188; 454/305; 137/315.01

(57) ABSTRACT

Air knives having improved end caps and mounting apparatuses are provided. Disclosed embodiments include a system having an air knife having first and second end caps that include recessed openings. Fasteners may extend through the recessed openings to fasten the first and second end caps to a main body of the air knife. The recessed openings prevent fasteners from protruding beyond the first end cap and the second end cap, thereby allowing for first and second mounting plates to be secured flush against the first and second end caps, respectively. In one embodiment, a mounting system including the first and second mounting plates may provide a first fastener that retains the air knife axially while providing a pivot point for rotational adjustments. A second fastener radially offset from the first fastener is configured to provide for rotational movement of the air knife about the pivot point.

### CROSS REFERENCE TO RELATED APPLICATION

This application claims the benefit of U.S. Provisional Patent Application No. 61/112,775, entitled “Air Knife,” filed on Nov. 9, 2008, which is herein incorporated by reference in its entirety.

### BACKGROUND

The present disclosure relates generally to fluid discharge devices and, more particularly, to fluid discharge devices configured to deliver a sheet or “blade” of air. Such a device is sometimes referred to as an “air knife.”

A variety of systems transfer fluids from a fluid supply source to one or more fluid discharge devices. In some systems, an arrangement of fluid conduits, which may include metal pipes, plastic pipes, and/or hoses, may provide a flow path for routing, channeling, or otherwise delivering a fluid from a fluid supply source to a fluid discharge device, such as an air knife. In the case of an air knife, air received via an inlet may be pressurized and directed through a slot-shaped outlet as a sheet or “blade” of air. The output of the air knife may be utilized for a variety of applications, such as drying and removing moisture from objects, removing dust or debris, cooling, and so forth.

### BRIEF DESCRIPTION

Certain aspects of embodiments disclosed herein by way of example are summarized below. It should be understood that these aspects are presented merely to provide the reader with a brief summary of certain forms an invention disclosed and/or claimed herein might take, and that these aspects are not intended to limit the scope of any invention disclosed and/or claimed herein. Indeed, any invention disclosed and/or claimed herein may encompass a variety of aspects that may not be set forth below.

Embodiments of an air knife system that includes improved end caps and mounting mechanisms are provided. In one embodiment, a system includes an air knife that includes a main body coupled to first and second end caps having recessed openings. Fasteners may extend through the recessed openings to fasten the first and second end caps to a main body of the air knife. Further, the recessed openings may prevent fasteners from protruding beyond the first end cap and the second end cap, thereby allowing for first and second mounting plates to be secured flush against the first and second end caps, respectively.

In a further embodiment, an air knife system includes a mounting system having first and second mounting plates configured to couple to first and second ends, respectively, of the air knife. One of the first or second mounting plates may be secured to the air knife via a first fastener that retains the air knife axially while providing a pivot point for rotational adjustments. A second fastener radially offset from the first fastener is configured to provide for rotational movement of the air knife about the pivot point.

### DRAWINGS

These and other features, aspects, and advantages of the present invention will become better understood when the following detailed description is read with reference to the accompanying drawings in which like characters represent like parts throughout the drawings, wherein:

FIG. 1 is a simplified block diagram depicting a fluid-based system having one or more air knives, in accordance with embodiments of the present disclosure;

FIGS. 2-4 are perspective views of an embodiment of an air knife that may be utilized in the system of FIG. 1;

FIG. 5 illustrates an embodiment of an end cap that may be secured to an inlet end of a main body of the air knife, as shown in FIGS. 2-4;

FIG. 6 illustrates an embodiment of an end cap that may be secured to an adjustment end of a main body of the air knife, as shown in FIGS. 2-4;

FIG. 7 is a more detailed side view of the embodiment of the end cap shown in FIG. 6 taken along line 7-7 of FIG. 3 that illustrates a recessed opening for receiving a fastener;

FIG. 8 is an exploded perspective view of the inlet side of the embodiment of the air knife shown in FIGS. 2-4;

FIG. 9 is an exploded perspective view of the adjustment side of the embodiment of the air knife shown in FIGS. 2-4;

FIG. 10 is a front view of the embodiment of the air knife shown in FIGS. 2-4 with the adjustment end facing forward, wherein the air knife is retained in a first rotational position by a tool-free fastener;

FIG. 11 is a partial cross-sectional view of the air knife, as shown in FIG. 10, taken along line 10-10; and

FIG. 12 is front view of the air knife, as shown in FIG. 10, wherein the air knife is repositioned to and retained at a second rotational position by the tool-free fastener.

### DETAILED DESCRIPTION

One or more specific embodiments will be described below. These described embodiments are provided only by way of example, and do not limit the scope of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments described below, the articles “a,” “an,” and “the” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Additionally, it should be understood that references to “one embodiment,” “an embodiment,” “some embodiments,” and the like are not intended to be interpreted as excluding the existence of additional embodiments that also incorporate the disclosed features.

As discussed in further detail below, various embodiments of an air knife system are provided with improved end caps and mounting systems. In one embodiment, a system includes an air knife having a main body coupled to first and second end caps with having recessed fastener openings. The recessed fastener openings may be used to fasten the first and second end caps to the main body of the air knife. Further, the recessed fastener openings may prevent fasteners from protruding beyond the first end cap and the second end cap, thereby allowing for first and second mounting plates to be secured flush against the first and second end caps, respectively. In another embodiment, an air knife system includes a mounting system having first and second mounting plates configured to couple to first and second end caps, respectively, of the air knife. One of the first or second mounting plates may be secured to the air knife via a first fastener and a second fastener. The first fastener retains the air knife axially while providing a pivot point for rotational adjustments. The second fastener may be a too-free fastener, such as a hand lever, thumb screw, or a latch, which is operable without use of a tool. In certain embodiments, the second fastener is radially offset from the first fastener and is selectively securable to block all movement and releasable to permit rotational movement of the main body relative to the respective mounting plate. In other words, the first fastener may provide only one degree of freedom (e.g., rotational movement) of the main body relative to the respective mounting plate.

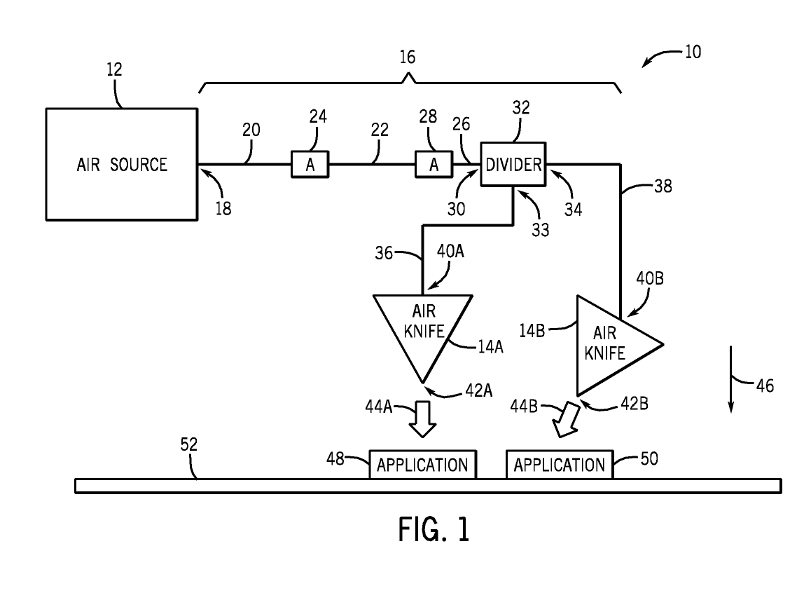

Turning now to the drawings, FIG. 1 illustrates a processing system 10 that may incorporate one or more aspects of the presently disclosed techniques. The processing system 10 includes an air supply source 12 that may deliver a fluid (e.g., air) to air knives 14A and 14B along a flow path 16. In the illustrated embodiment, the flow path 16 includes the fluid conduits 20, 22, 26, 36, and 38, the adapters 24 and 28, and the divider 32.

In the presently illustrated system 10, the air supply source 12 may include a high flow centrifugal blower (“air blower”) which, in some embodiments, may include a supercharger and motor configuration. In one embodiment, the operating characteristics of the air blower 12 may provide an air flow having a pressure of between approximately 1-10 pounds per square inch (psi) and having a flow rate of between approximately 50-2000 cubic feet per minute (CFM) or more specifically, between approximately 150 to 1500 CFM. In some embodiments, the air blower 12 may be housed within an enclosure. The air blower 12 may be separated from the air knives 14A and 14B by a distance of 10, 20, 30, 40, 50, 100, or 200 feet or more. As such, the flow path 16 is configured to provide a path through which air provided by the air blower 12 may be routed and ultimately delivered to the air knives 14A and 14B.

The air blower 12 may include an outlet 18 coupled to the fluid conduit 20 that defines a first portion of the flow path 16. The fluid conduit 20 may be coupled to the downstream fluid conduit 22 by way of a first adapter 24. By way of example only, the fluid conduit 20 may be a hose, such as a flexible hose, and the fluid conduit 22 may be a pipe, such as a stainless steel pipe or a polyvinyl chloride (PVC) pipe. The adapter 24 may be configured to provide an interface for coupling the hose 20 and pipe 22. For instance, the adapter 24 may include a first adapter end configured to couple to the hose 18, and a second adapter end configured to couple to the pipe 20. In this manner, the hose 20, adapter 24, and pipe 22 are fluidly coupled, thereby allowing air discharged from the outlet 18 of the blower 12 to flow from the hose 20 into the pipe 22.

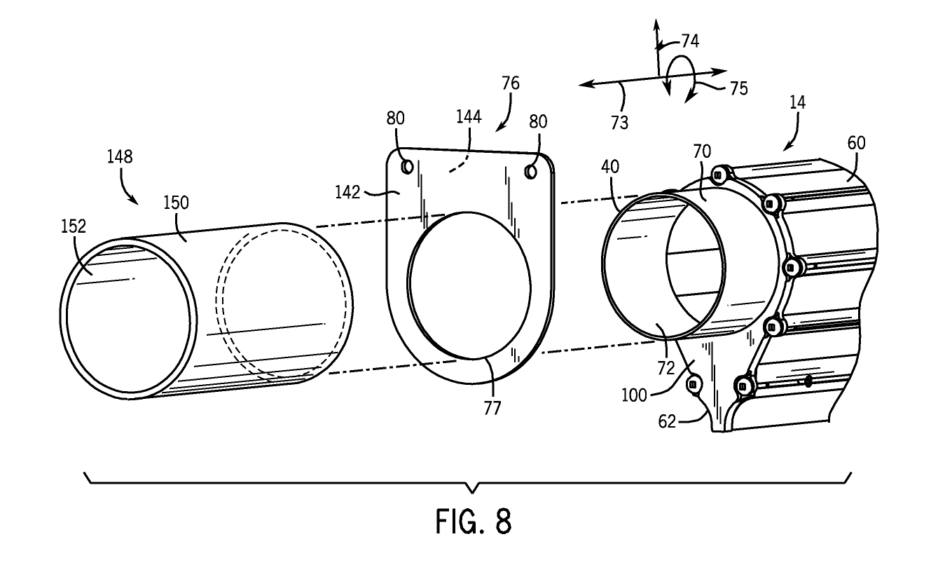

The flow path 16 continues to the distal end of the pipe 22, which may be coupled to another hose 26 by way of a second adapter 28 that may be similar in design to the first adapter 24. Thus, by way of the adapters 24 and 28, the air flow from the blower 12 may be received by an inlet 30 of a manifold or flow divider 32. The divider 32 may be configured to distribute or split the air flow to multiple outlets 33 and 34. Additional fluid conduits 36 and 38 may respectively couple the outlets 33 and 34 to the air knives 14A and 14B, respectively. In the illustrated embodiment, the air knives 14A and 14B may each include an inlet (40A and 40B) configured for a hose connection, and the fluid conduits 36 and 38 may thus be provided as hoses, such as flexible hoses. In other embodiments, a pipe may be disposed between the divider 32 and one of the air knives 14A or 14B, whereby adapters similar to the above-discussed adapters 24 or 28 are coupled to each end of the pipe to facilitate a fluid connection between hoses extending from an outlet (e.g., 33 or 34) of the divider 32 and from an inlet (e.g., 40A or 40B) of one of the air knives (e.g., 14A or 14B). A hose connection to an inlet of an air knife will be illustrated in more detail below with respect to FIG. 8. In some embodiments, the system 10 may include only a single air knife (e.g., 14A) and thus may not include a divider 32. In such embodiments, the fluid conduit 26 may be coupled directly to the air knife 14A.

As will be discussed further below, the air knife 14A may include a main body having first and second end caps that define a plenum or fluid cavity for receiving an air flow via the inlet 40A. In certain embodiments, the air knife 14A may be formed of materials including aluminum, stainless steel, or some combination thereof. In some embodiments, the main body may be generally cylindrical in shape with one end along the cylindrical body tapering to form a narrow discharge outlet 42A, which may include a single continuous slot or, in other embodiments, a series of narrow holes or openings. In embodiments utilizing such a design, the main body of the air knife 14A may generally take the form of a tear drop shape.

In operation, the plenum may pressurize and discharge air received via the inlet 40A through the outlet 42A. By way of example, an outlet 42A in the form of a continuous “discharge slot” may have a width of between approximately 0.025 to 0.1 inches, and may have an area that is substantially less than the area of the inlet 42A. Accordingly, the air flow 44A (which may take the form of an air “blade” having a “knife-like” edge) exiting the outlet 42A of the air knife 14A may have a velocity that is greater than the velocity of the air flow entering via the inlet 40A. As can be appreciated, the air knife 14B may be constructed in a manner that is similar to the air knife 14A and, thus may operate in a similar manner. Further, while only two outlets 33 and 34 are shown in FIG. 1, it should be appreciated that the divider 26 may be configured to provide any suitable number of outlets, and may provide flow paths to any suitable number of devices, including additional air knives, additional dividers, manifolds, and so forth.

As shown in FIG. 1, the air flows 44A and 44B exiting the respective discharge slots 42A and 42B of each of the air knives 14A and 14B, may be directed towards the applications 48 and 50, respectively, of the processing system 10. For instance, the applications 48 and 50 may be transported through the system 10 along a conveyor belt 52 or some other suitable type of transport mechanism. As will be appreciated, the application represented by the system 10 may utilize the air flows 44A and 44B provided by the air knives 14A and 14B, respectively, for a variety of functions, including but not limited to drying products, removing dust or debris, coating control, cooling, leak detection, surface impregnation, corrosion prevention, and so forth. For instance, in certain embodiments, the system 10 may be a system for drying food or beverage containers, such as cans or bottles, or may be a system for removing dust and other debris from sensitive electronic products, such as printed circuit boards (PCBs) or the like. In addition, some embodiments of the system 10 may also utilize the air flows 44A and 44B may to clean and/or remove debris from the conveyer belt 52.

In accordance with aspects of the present disclosure, the air knives 14A and 14B may each include an adjustable mounting system that enables a user to position each air knife so as to direct the exiting air flows 44A and 44B in a desired direction. For instance, in FIG. 1, the air knife 14A is mounted within the system 10 and oriented such that the exiting air flow 44A is directed in the downward vertical direction 46. By comparison, the air knife 14B is mounted within the system 10, such that the exiting air flow 44B is directed towards the application 50 at an angle that is offset with respect to the vertical direction 46. As discussed below, the disclosed embodiments of the air knife 14A and 14B may provide angular positions ranging over a span of at least approximately 90, 180, 270, or 360 degrees, or an angular range between 0 and 360 degrees.

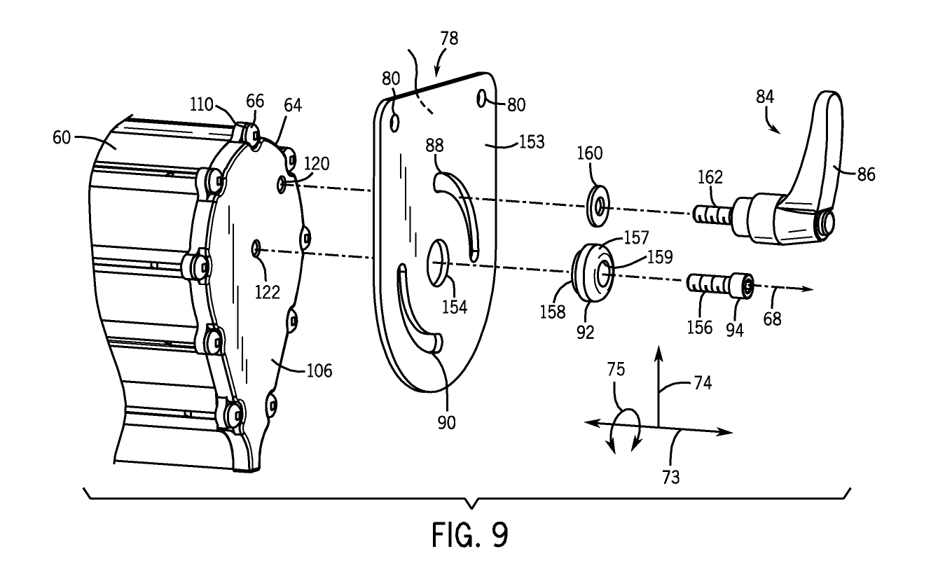

In certain embodiments, the adjustable mounting system may include a mounting plate that is fastened to a pivot point on an end cap secured to one end of the air knife body using a first fastener in conjunction with a spacer or standoff element. The first fastener blocks movement in an axial direction while the standoff provides clearance to enable pivotal movement in a rotational direction about the pivot point. A second fastener may be received at an adjustment point on the end cap that is radially offset from the pivot point. When the air knife is oriented to a desired position, rotational retention may be provided by securing the second fastener within the adjustment point. Such a mounting system will be discussed in further detail below with respect to FIGS. 9-12.

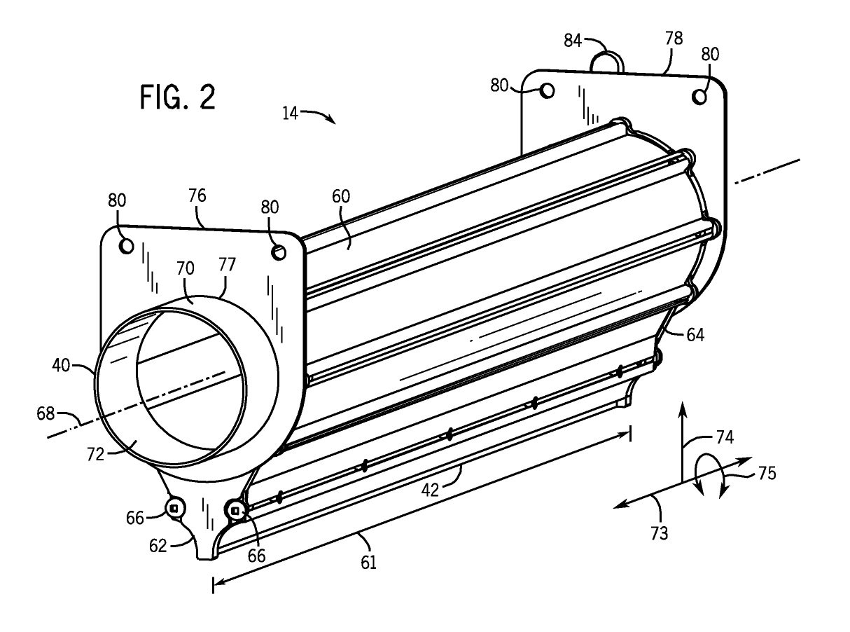

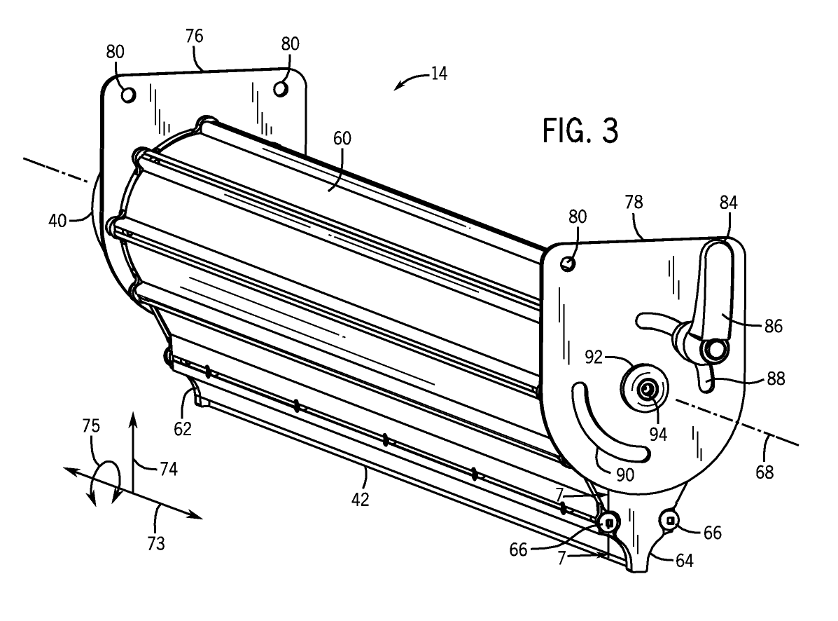

Referring now to FIGS. 2-4, several perspective views showing an embodiment of an air knife 14 that may be utilized in the system 10 of FIG. 1 are illustrated. In order to facilitate a better understanding of the disclosure, FIGS. 2-4 will generally be described together. Specifically, FIG. 2 shows a perspective view of the air knife 14 from an inlet end. FIG. 3 shows a perspective view of the air knife 14 from an adjustment end, opposite the inlet end. Further, FIG. 4 shows another perspective view of the air knife 14 from the inlet end to more clearly depict the outlet 42.

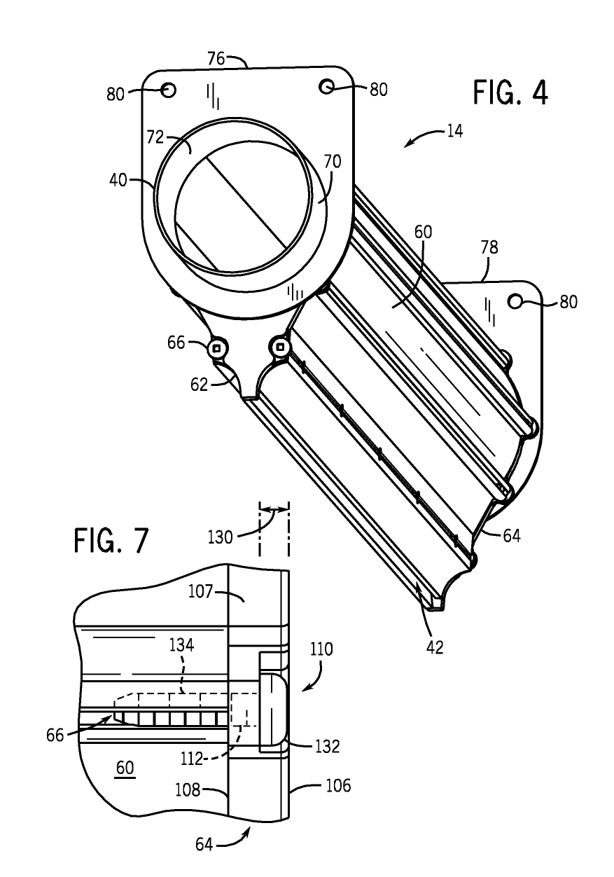

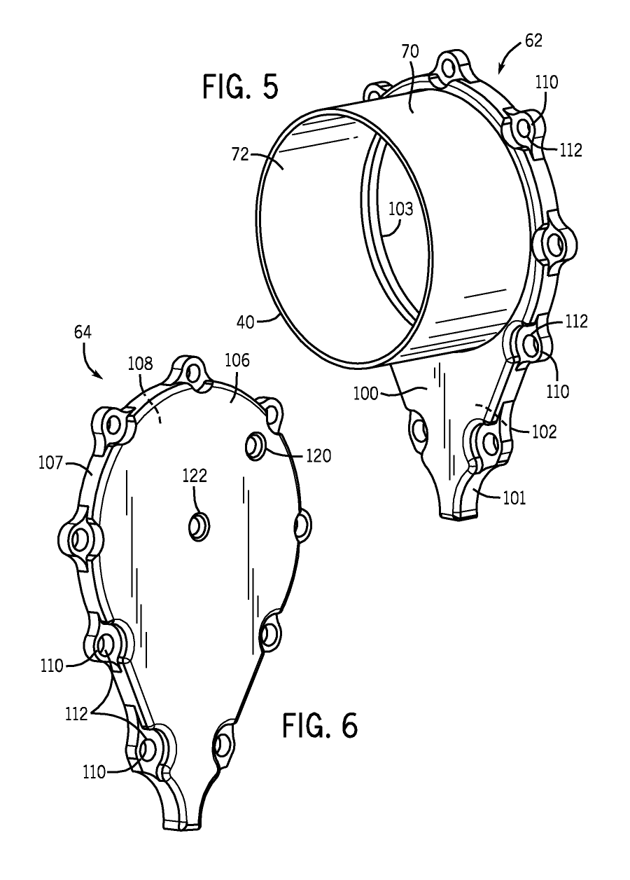

As shown in FIGS. 2-4, the air knife 14 includes a main body 60 which may have an axial length 61 (e.g., in the axial direction 73). By way of example only, the axial length 61 of the main body may be between approximately 0.5 feet to 4 feet (e.g., 0.5, 1, 1.5, 2, 2.5, 3, 3.5, or 4 feet). A first end cap 62 that includes the inlet 40 and a second end cap 64 are secured to opposite first and second ends of the main body 60 by one or more fasteners 66. The fasteners 66 may be provided as screws, bolts, rivets, latches, stakes, or some other suitable type of fastening device. As discussed in more detail below with respect to FIGS. 5-7, the fasteners 66 are configured to secure the first end cap 62 (an “inlet-side end cap”) and the second end cap 64 (an “adjustment-side end cap”) through recessed openings formed along the outer perimeter of each end cap 62 and 64. For instance, the fasteners 66 may be inserted through the recessed openings on the end caps 62 and 64 and into holes (not shown) on the main body 60. In this manner, the main body 60 and the end caps 62 and 64 define a plenum or fluid cavity that receives an air flow entering via the inlet 40.

In the present embodiment, the main body 60 has a tear drop shape or airfoil shape which includes a taper that forms a discharge slot 42. In certain embodiments, the discharge slot 42 may have a width of between approximately 0.025 to 0.1 inches, and may have a length that is approximately equivalent to the length 61 of the main body 60. Accordingly, air entering the inlet 40 may be pressurized within the main body 60 and discharged through the slot 42, generally having an impact velocity that is greater than the velocity of the air entering the main body 60 via the inlet 40. The main body 60 and the end caps 62 and 64 may be formed from aluminum, stainless steel, or any other type of suitable material that may provide a fluid-tight cavity for receiving the air flow via the inlet 40.

As shown in FIG. 2, the inlet side of the air knife 14 includes the inlet 40 (e.g., an annular protrusion), which has an annular outer wall 70 and an annular inner wall 72. An adjustable mounting system, which may include the mounting plates 76 and 78, are also provided, and may be retained against the end caps 62 and 64, respectively, as discussed below. The mounting plate 76 (referred to as the inlet-side mounting plate), which includes an opening 77 (e.g., a circular opening), may be fitted against the inlet-side end cap 62 such that the inlet 40 fits through the opening 77. As will be appreciated, the inlet 40 and the opening 77 may be sized to accommodate any suitable fluid conduit for delivering and air flow from the blower 12 (FIG. 1). For instance, in some embodiments, the inlet 40 may be joined to a fluid conduit, such that the outer wall 70 fits against an inner wall of the fluid conduit. By way of example only, the inlet 40 may be configured to fit with a flexible hose having an inside diameter of between approximately 2 to 6 inches (e.g., 2, 2.5, 3, 3.5, 4, 4.5, 5, 5.5, or 6 inches).

In some embodiments, the outer wall 70 of the inlet 40 may include one or more surface features, such as spiral-shaped grooves or gripping teeth, which may grip the inner wall of the hose, thus facilitating a secure connection between the hose and the inlet 40. The connection of the inlet 40 to the fluid conduit may thus retain the inlet-side mounting plate 76 in the axial direction 73, i.e., between the inlet-side end cap 62 and a fluid conduit, while allowing the mounting plate 76 to rotate about the inlet 40 in the rotational direction 75.

Referring to FIG. 3, the adjustment end of the air knife 14 includes the mounting plate 78 (referred to as the “adjustment-side mounting plate”), a tool-free fastener 84 with a handle 86 (e.g., a lever), a separator element 92 (e.g., a spacer or standoff), and a fastener 94 (e.g., a screw). The adjustment-side mounting plate 78 includes arcuate grooves or slots 88 and 90 that are radially offset (e.g., radial direction 74) from the fastener 94. The end cap 64 may include an opening, such as a threaded hole, for receiving mating threads of the fastener 94. As will be discussed in further detail below, the separator element 92 and the fastener 94 may provide axial retention (e.g., in direction 73) of the air knife 14, but still permit a degree of rotational movement (e.g., in the rotational direction 75) suitable for pivoting the main body 60 about the rotational axis 68 to adjust the rotational position of the air knife 14. In other words, the separator element 92 and the fastener 94 provide only one degree of freedom (e.g., rotational movement of the main body 60 relative to the mounting plate 78). In this manner, the direction of the exiting air flow 44 from the discharge slot 42 may be adjusted.

Once the air knife 14 has been oriented to a desired position, retention in the rotational direction may be accomplished via the tool-free fastener 84. For instance, once a desired rotational position is obtained, the tool-free fastener 84 may be inserted through one of the arcuate grooves 88 or 90 and secured into a threaded hole on the end cap 64. The tool-free fastener 84 may then be tightened via the handle 86 to retain the desired rotational position. As can be appreciated, the amount of adjustment in the rotational direction 75 is defined by the angular range provided by the arcuate grooves 88 and 90. By way of example only, each of the arcuate grooves may provide an angular range of rotational movement over a span of at least approximately 90, 180, 270, or 360 degrees, or an angular range between 0 and 360 degrees.

As further shown in FIGS. 2-4, the mounting plates 76 and 78 each include openings 80, which may be used to couple the mounting plates 76 and 78 to a component of the system 10 (FIG. 1). Thus, in practice, the adjustable mounting system of the air knife 14 may be utilized such that the mounting plates 76 and 78 are fixedly coupled or anchored to the system 10, and such that the mounting plates 76 and 78 may be coupled to a component of the system 10, such as a stationary mounting arm, a robotic arm, or the like. Axial retention of the air knife 14 is provided on the inlet end by the connection of a fluid conduit to the inlet 40, and on the adjustment end via the fastener 94 and separator element 92. Prior to securing (e.g., tightening a threaded connection of) the tool-free fastener 84, the air knife 14 may be pivoted about the rotational axis 68 until a desired orientation is obtained, at which point the tool-free fastener 84 may be secured to retain the desired rotational position. These features are illustrated more clearly with respect to FIGS. 8-12, which are described further below.

Referring now to FIGS. 5 and 6, the end caps 62 and 64 of FIGS. 2-4 are illustrated in more detail. Specifically, FIG. 5 shows the inlet-side end cap 62, and FIG. 6 shows the adjustment-side end cap 64. As illustrated, the inlet-side end cap 62 has an outer face 100, an inner face 102 (with the reference lead line shown partially in phantom), and a perimeter or edge 101 extending therearound and defining a thickness of the inlet-side end cap 62. The inlet-side end cap 62 includes an opening 103 from which the inlet 40 extends. As discussed above, the inlet 40 includes an outer wall 70 that may be adapted to couple against an inner wall of a fluid conduit that provides an air flow (e.g., supplied by blower 12) to the air knife 14.

The adjustment-side end cap 64 similarly includes an outer face 106, an inner face 108 (with the reference lead line shown partially in phantom), and a perimeter or edge 107 extending therearound and defining a thickness of the adjustment-side end cap 64. It should be noted that in the present embodiment, the perimeters 101 and 107 of the end caps 62 and 64, respectively, define shapes that are substantially the same as the “tear drop” cross-sectional shape of the main body 60 (e.g., taken through a radial plane perpendicular to the longitudinal rotational axis 68). The adjustment-side end cap 64 also includes the openings 120 and 122. The opening 122 may receive a threaded end of the fastener 94 which, in combination with the separator element 92, provides axial retention of the air knife 14 and mounting plate 78. The opening 120 may receive a threaded end of a tool-free fastener 84 to provide rotational retention of the air knife 14. Thus, when securely threaded into each of the respective openings 120 and 122, the fastener 94 and the tool-free fastener 84 (FIGS. 2-4) may retain the position of the air knife 14 in axial (e.g., direction 73) and rotational (e.g., direction 75) directions, such that the “knife-edged” air flow exiting the discharge slot 42 may be directed towards a particular application (e.g., 48 or 50).

As shown in FIGS. 5 and 6, each of the end caps 62 and 64 may include a plurality of recesses 110 formed along their respective edges 101 and 107. Within each recess 110, an opening 112 is provided through which a respective fastener 66 (e.g., FIGS. 2-4) may be inserted to secure the end caps 62 and 64 to the main body 60 of the air knife via threaded connections. For instance, the recessed openings 112 on the end caps 62 and 64 may generally align to corresponding screw holes on the inlet-side end and the adjustment-side end of the main body 60, and the end caps 62 and 64 may be secured to the main body 60 by tightening the fasteners 66 within their respective corresponding threaded holes.

FIG. 7 illustrates a more detailed side view of a recess 110 on the end cap 64 taken along line 7-7 of FIG. 3. As depicted in FIG. 7, the adjustment-side end cap 64 may be secured against the main body 60 by one or more screws 66. Each screw 66 may include a head 132 and a threaded portion 134 (shown in phantom). As illustrated, the screw 66 may be inserted through the recessed opening 112 of the recess 110 into a corresponding screw hole of the main body 60. The opening 112 may be recessed from the outer face 106 of the end cap 64 by a distance 130. In accordance with aspects of the present disclosure, the distance 130 may be selected such that the head 132 of the screw 66, when threaded to the main body 60, does not extend beyond the outer face 106 of the end cap 64. In other words, the head 132 may be flush or recessed relative to the outer face 106. By way of example only, the distance 130 may be between approximately 0.25 to 2 inches (e.g., 0.25, 0.3, 0.4, 0.5, 0.6, 0.7, 0.8, 0.9, 1.0, 1.25, 1.5, 1.75, or 2 inches).

Although FIG. 7 shows a detailed view of a recess 110 on the adjustment-side end cap 64 of FIG. 6, it should be understood that the recesses 110 on the inlet-side end cap 62 may be formed in a similar manner. Thus, the recessed openings 112 may allow for the screws 66 to secure the end caps 62 and 64 to the main body 60 without protruding beyond their respective outer surfaces 100 and 106. As will be appreciated, this technique of providing recessed openings 110 for the fasteners 66 allows for the mounting plate 76 to fit flush against the outer face 100 of the inlet-side end cap 62, and also allows for the mounting plate 78 to fit flush against the outer face 106 of the adjustment-side end cap 64.

The manner in which the mounting plates 76 and 78 may be fitted against the end caps 62 and 64 may be better understood with reference to FIGS. 8 and 9. In particular, FIG. 8 shows a partial perspective exploded view depicting how the mounting plate 76 and a fluid conduit 148 are fitted to the inlet end of the air knife 14. FIG. 9 further shows a partial perspective exploded view depicting how the mounting plate 78 may be secured to the adjustment end of the air knife 14 via the fasteners 84 and 94.

Referring first to FIG. 8, the mounting plate 76 includes the opening 77, an outer face 142, and an inner face 144 (with the reference lead line shown partially in phantom). The inlet 40 (e.g., annular protrusion) may be figured to fit through the opening 77, such that the inner face 144 of the mounting plate 76 fits against the outer face 100 of the end cap 62. As discussed above, because the recessed openings 112 (FIGS. 5-7) provide that the heads (e.g., 132) of the fasteners 66 do not extend or protrude beyond the outer face 100, the mounting plate 76 may be fitted flush against the outer face 100.

A fluid conduit 148, such as a hose, includes an outer wall 150 and an inner 152. The inner wall 152 of the hose 148 may fit against the outer wall 70 of the inlet 40. As discussed above, in some embodiments, the outer wall 70 of the inlet 40 may include one or more surface features, such as spiral-shaped grooves or gripping teeth, which may grip the inner wall 152 of the hose 148, thus facilitating a secure connection between the hose 148 and the inlet 40. When assembled onto the inlet 40, the hose 148 may provide axial retention with regard to the mounting plate 76. That is, the mounting plate 76 may be held in place by the hose 148 and the outer face 100 of the end cap 62.

As mentioned above, the assembly of the adjustment-side mounting plate 78 to the end cap 64 may be facilitated by the fasteners 84 and 94. For instance, as shown in FIG. 9, the mounting plate 78 includes an outer face 153 and an inner face 155 (with the reference lead line shown partially in phantom). The separator element 92, which may include an axial spacer or standoff, and the fastener 94 may provide for axial retention of the air knife 14 (e.g., in the axial direction 73), while still allowing for the rotational position of the air knife 14 to be pivoted about the longitudinal axis 68. For instance, the separator 92 includes an inner cylindrical portion 158 that has a smaller diameter compared to an outer cylindrical portion 157. The inner cylindrical portion 158 may be fitted into the circular opening 154 on the mounting plate 78, leaving the outer cylindrical portion 157 to extend from the outer face 153. The fastener 94 includes a threaded portion 56, which may be inserted through an opening 159 of the separator 92 and the opening 154 of the mounting plate 78 and threaded into the hole 122, thereby securing the inner face 155 of the mounting plate 78 to the outer face 106 of the end cap 64 and providing for axial retention of the air knife 14. As discussed above, due to the recesses 110, the mounting plate 78 may be fitted flush against the outer face 106.

As shown in the present embodiment, the hole 122, opening 154, separator 92, and fastener 94 are all generally aligned with the longitudinal axis 68 of the air knife 14. While the fastener 94 and separator 92 provide axial retention (e.g., via a friction fit), the rotational position of the air knife 14 may still be adjustable prior to tightening the tool-free fastener 84 within the hole 120, i.e., via pivoting the air knife 14 about the longitudinal axis 68. As discussed above, the tool-free fastener 84 includes a handle or lever 86 that enables a user to turn the fastener 84 clockwise or counter-clockwise without a separate tool. The assembly of the tool-free fastener 84 to the hole 120 may include inserting a threaded portion 162 of the fastener 84 through a washer 160 and through one of the arcuate grooves 88 or 90. As discussed above, the arcuate grooves 88 and 90 may be provide for an angular range of rotational movement with respect to the rotational axis 68, at which the fastener 94 acts as the pivot point. Thus, the relative location of the hole 120 for receiving the threaded portion 162 of the tool-free fastener 84 may vary within grooves 88 or 90 depending on the rotational position (e.g., in rotational direction 75) of the air knife 14.

To retain a particular rotational position, the tool-free fastener 84 may be tightened (e.g., via clockwise rotation) within the threaded hole 120. The foregoing technique provides for relatively easy adjustment of the rotational position of the air knife 14 to adjust the direction of the exiting air flow 44 (FIG. 1) by: loosening (e.g., via counter-clockwise rotation) the tool-free fastener 84, repositioning the air knife 14, and then re-tightening the tool-free fastener 84 once a new desired rotational position is obtained. As will be appreciated, the rotational adjustment of the air knife 14 may be performed without completely removing the tool-free fastener 84 from the hole 120. That is, the tool-free fastener 84 need only be loosened to allow for movement within the grooves 88 or 90 (although complete removal of the fastener 84 may be necessary if a user wishes to reposition the location of the hole 120 from the groove 88 to the groove 90).

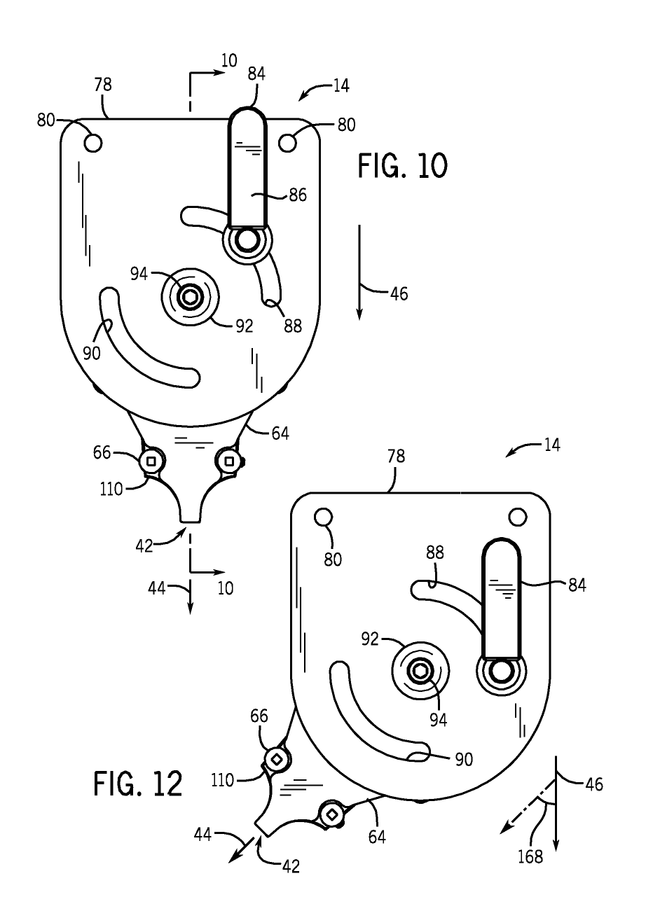

FIGS. 10-12 depict the adjustment side of the air knife 14, and further illustrate how the rotational position of the air knife 14 may be adjusted. For clarity, elements illustrated in FIGS. 10-12 that have already been described above are labeled using like reference numbers. FIG. 10 illustrates a front view of the air knife 14 with the adjustment end facing forward. As shown, the air knife 14 is retained in a first rotational position, such that the air flow 44 exiting the discharge slot 42 is directed downwards in the vertical direction 46.

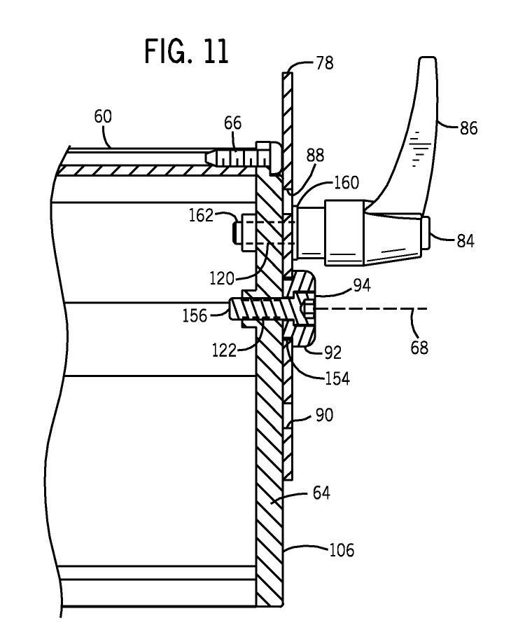

A cross-sectional view (taken along cut-line 10-10) of the air knife 14 in the first rotational position is further depicted in FIG. 11. As shown, the mounting plate 78 is secured flush against the adjustment-side end cap 64. The separator 92 and fastener 94 are inserted through the opening 154 of the mounting plate 78, and the threaded portion 156 of the fastener 94 may be threaded into the hole 122 to provide axial retention of the air knife 14. Additionally, the threaded portion 162 of the tool-free fastener 84, which is inserted through the washer 160 and the arcuate groove 88, is threaded within the hole 120 to provide retention of the air knife 14 in the first rotational position, as shown in FIG. 10.

FIG. 12 shows a front view of the air knife 14 with the adjustment end facing forward, wherein the air knife 14 is repositioned to a second rotational position. As discussed above, the rotation of the air knife 14 may be about the rotational axis 68 (FIGS. 2-4), whereby the fastener 94 acts as a pivot point for rotational movement. In the illustrated second rotational position of FIG. 12, the air knife 14 is rotated clockwise to an angle 168 with respect to the vertical direction 46, such that the air flow 44 exits the discharge slot 42 at the angle 168. As discussed above, adjusting the rotational position of the air knife 14 from the first rotational position of FIG. 10 to the second rotational position of FIG. 12 may include loosening the tool-free fastener 84, repositioning the air knife 14 to the second rotational position, and then re-tightening the tool-free fastener 84 after obtaining the second rotational position. In this manner, the mounting system, which includes the plates 76 and 78 and the tool-free fastener 84, may provide a technique for adjusting the position of an air knife that may be accomplished with relative ease and without requiring separate tools.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
an air knife comprising:
a main body comprising a first end and a second end;
a first end cap comprising a first plurality of recessed openings, wherein the first plurality of recessed openings is configured to enable recessed fastening of the first end cap to the first end of the main body; and
a second end cap comprising a second plurality of recessed openings, wherein the second plurality of recessed openings is configured to enable recessed fastening of the second end cap to the second end of the main body.

2. The system of claim 1, wherein the first plurality of recessed openings are arranged along a first perimeter of the first end cap, and wherein the second plurality of recessed openings are arranged along a second perimeter of the second end cap.

3. The system of claim 1, wherein:
the first end cap is secured to the first end of the main body via a first plurality of threaded fasteners, wherein each one of the first plurality of fasteners extends through one of the first plurality of recessed openings and into a first threaded hole in the main body; and
the second end cap is secured to the second end of the main body via a second plurality of threaded fasteners, wherein each one of the second plurality of fasteners extends through one of the second plurality of recessed openings and into a second threaded hole in the main body.

4. The system of claim 3, wherein each one of the first plurality of threaded fasteners does not protrude beyond a first outer face of the first end cap when secured in one of the first plurality of recessed openings, and each one of the second plurality of threaded fasteners does not protrude beyond a second outer face of the second end cap when secured in one of the second plurality of recessed openings.

5. The system of claim 1, comprising an adjustable mounting system coupled to the air knife, wherein the adjustable mounting system comprises a first mounting plate coupled to the first end cap, and a second mounting plate coupled to the second end cap.

6. The system of claim 5, wherein the first mounting plate is flush against a first outer face of the first end cap when secured to the first end cap, and the second mounting plate is flush against a second outer face of the second end cap when secured to the second end cap.

7. The system of claim 5, wherein the first mounting plate is configured to couple with an external mount via a first plurality of mounting holes, and the second mounting plate is configured to couple with the external mount via a second plurality of mounting holes.

8. The system of claim 7, wherein the air knife is configured to rotate about a longitudinal axis between a plurality of positions relative to the first and second mounting plates, wherein the adjustable mounting system comprises a tool-free fastener configured to secure the air knife in one of the plurality of positions.

9. The system of claim 8, wherein the first mounting plate comprises a central opening and an arcuate slot radially offset from the central opening, the tool-free fastener comprises a lever having a first threaded fastener extending through the arcuate slot, and the adjustable mounting system comprises a threaded fastener extending through an axial spacer disposed in the central opening.

10. A system, comprising:
a mounting system, comprising:
a first mounting plate having a first opening and at least one arcuate groove radially offset from the first opening and extending circumferentially about the first opening;
a first fastener configured to fit through the first opening and to be threaded within a first hole on a first end of a fluid discharge device, wherein the first fastener provides axial retention of the first mounting plate to the first end when threaded within the first hole, wherein the first opening and the first hole are generally aligned with a longitudinal rotational axis of the fluid discharge device; and
a second fastener configured to fit through the at least one arcuate slot and to be threaded within a second hole on the first end of the fluid discharge device, wherein the second hole is radially offset from the first hole, wherein the second fastener provides rotational retention of the first mounting plate to the first end when threaded within the second hole, and wherein the second fastener is releasable to allow the fluid discharge device to pivot about the longitudinal rotational axis.

11. The system of claim 10, comprising the fluid discharge device coupled to the mounting system, wherein the fluid discharge device comprises an air knife.

12. The system of claim 10, comprising a second mounting plate having a second opening and configured to fit over a fluid inlet extending from a second end of the fluid discharge device and to be held against the second end by a fluid conduit coupled to the fluid inlet.

13. The system of claim 12, wherein each of the first and second mounting plates comprises at least one mounting hole configured to receive a fastener for anchoring each of the first and second mounting plates to an external structure.

14. The system of claim 10, wherein the second fastener comprises a tool-free fastener having a handle or a lever that enables a user to tighten and loosen the second fastener without a separate tool.

15. The system of claim 10, wherein the arcuate groove provides an angular range of rotation for pivoting the fluid discharge device, the angular range being between approximately 10 to 180 degrees.

16. The system of claim 10, comprising an axial standoff secured between the first fastener and the first mounting plate.

17. The system of claim 16, comprising a washer secured between the second fastener and the first mounting plate.

18. A system, comprising:
an air knife, comprising:
a main body;
a first end cap coupled to a first end of the main body via a first fastener extending through a first recessed opening;
a second end cap coupled to a second end of the main body via a second fastener extending through a second recessed opening, wherein the main body, the first end cap, and the second end cap surround an air cavity;
an air inlet configured to direct an air flow into the air cavity; and
an air discharge slot extending axially along the main body, wherein the air discharge slot is configured to discharge the air flow out of the air cavity.

19. The air knife of claim 18, wherein the air knife is configured to be axially retained between a first mounting plate secured to the first end cap and a second mounting plate secured to the second end cap, and wherein the rotational position of the air knife about a longitudinal rotational axis is adjustable using a tool-free fastener.

20. The air knife of claim 19, wherein at least one of the first and second mounting plates comprises an arcuate slot radially offset and extending circumferentially about the a longitudinal rotational axis, wherein the arcuate groove is configured to receive the tool-free fastener.
